(19) United States
(12) Patent Application Publication
(10) Pub. No.: US 2026/0356273 A1
(43) Pub. Date: Nov. 12, 2026

(54) CONTAINER CAR SHORING FRAME

(71) Applicant: JE WON PARK, Busan (KR)

(72) Inventors: Nam Sik HONG, Changwon-si (KR); Myeong Dong HWANG, Changwon-si (KR)

(21) Appl. No.: 19/392,735

(22) Filed: Nov. 18, 2025

Related U.S. Application Data
(63) Continuation of application No. PCT/KR2025/005832, filed on Apr. 29, 2025.

(30) Foreign Application Priority Data
May 24, 2024 (KR) 10-2024-0067901

(51) Int. Cl. B60P 3/075; B65D 90/00

(52) U.S. Cl. CPC B60P 3/075; B65D 90/0073

(57) ABSTRACT

A container car shoring frame includes a base frame configured to be mounted on the ground and allow the rear wheels of a vehicle to be seated thereon; a lifting ladder configured to be rotatably hung on the upper front of the base frame and allow the front wheels of the vehicle to be seated on the upper front thereof; first supporters configured to be rotatably coupled to the front of the lifting ladder and support the front of the lifting ladder when the lifting ladder is rotated counterclockwise; second supporters configured to be rotatably coupled to the center of the lifting ladder and support the center of the lifting ladder when the lifting ladder is rotated counterclockwise; and third supporters configured to be fixedly connected to the rear of the lifting ladder and support the rear of the lifting ladder.

### CROSS-REFERENCE TO RELATED APPLICATIONS

This application is a Continuation of PCT/KR2025/005832 filed on Apr. 29, 2025, which claims priority from Korean Patent Application No. 10-2024-0067901 filed on May 24, 2024. The aforementioned applications are incorporated herein by reference in their entireties.

### BACKGROUND

### 1. Technical Field

The present invention relates to a container car shoring frame, and more particularly, to a container car shoring frame in which a vehicle is disposed in an inclined form in an up-forward direction and then another vehicle is loaded horizontally in the space between the existing vehicle and the floor of a container, thus being able to maximally utilize the space inside the container in order to load vehicles thereinto.

### 2. Description of the Related Art

Container ships are ships that are most widely used in maritime transportation, and are ships that transport cargo. More specifically, container ships are ships that carry multiple containers throughout the ships and navigate.

When vehicles are exported, multiple vehicles are loaded into multiple containers, and then the multiple containers are loaded onto a container ship. When vehicles are transported via container ships, one of the most important factors is the transportation cost. When vehicles are loaded into containers, as many vehicles as possible can be loaded into a container by maximally utilizing the space inside the container, thereby reducing the transportation cost per vehicle.

Shoring refers to the work of disposing vehicles inside a container so that the maximum number of vehicles can be loaded into the container. However, the insides of conventional containers are each formed in a rectangular parallelepiped shape, so that there is a problem in that, when vehicles are loaded into a container in a horizontal direction, it is difficult to load the maximum number of vehicles into the container.

### SUMMARY

The present invention has been conceived to overcome the above-described problems, and an object of the present invention is to provide a container car shoring frame, in which a vehicle is disposed in an inclined form in an up-forward direction and then another vehicle is loaded horizontally in the space between the existing vehicle and the floor of a container, thus being able to maximally utilize the space inside the container in order to load vehicles thereinto.

An object of the present invention is to provide a container car shoring frame, in which the rear wheels of a vehicle are seated on the tops of tire frames through a lifting ladder in the state in which the lifting ladder is hung on the upper fronts of the tire frames of a base frame and then the lifting ladder on which the front wheels of the vehicle are seated is rotated counterclockwise around the tire frames, so that the vehicle can be disposed in an inclined form in an up-forward direction, thus being able to load as many vehicles as possible inside a container.

An object of the present invention is to provide a container car shoring frame, in which another vehicle may be additionally loaded between a lifting ladder disposed in an inclined form in an up-forward direction and the bottom of a container, thus being able to reduce the transportation cost per vehicle during the export of vehicles.

In order to accomplish at least one of the above objects, the present invention provides a container car shoring frame, including: a base frame configured to be mounted on the ground and allow the rear wheels of a vehicle to be seated on the top thereof; a lifting ladder configured to be rotatably hung on the upper front of the base frame and allow the front wheels of the vehicle to be seated on the upper front thereof; first supporters configured to be rotatably coupled to the front of the lifting ladder and support the front of the lifting ladder when the lifting ladder is rotated counterclockwise; second supporters configured to be rotatably coupled to the center of the lifting ladder and support the center of the lifting ladder when the lifting ladder is rotated counterclockwise; and third supporters configured to be fixedly connected to the rear of the lifting ladder and support the rear of the lifting ladder when the lifting ladder is hung on the upper front of the base frame; wherein the lifting ladder is rotated counterclockwise in order to lift the front wheels of the vehicle; wherein the base frame includes: a base part configured to be mounted on the ground; and tire frames configured to be fixedly coupled to both sides of the base part, respectively, and allow the rear wheels of the vehicle to be seated thereon; and wherein the lifting ladder includes: ladders configured such that the rear ends thereof are hung on the upper fronts of the tire frames in order to move the rear wheels of the vehicle to the tire frames; and horizontal members configured to be fixedly coupled to the lower fronts of the ladders at a plurality of locations spaced apart from each other.

The tire frames may include: support parts configured to be fixedly coupled to both sides of the rear of the base part, respectively; seating parts configured to be fixedly coupled to the tops of the support parts and allow the rear wheels of the vehicle to be seated thereon; and stoppers configured to be fixedly coupled to the upper rears of the seating parts and prevent the rear wheels of the vehicle from being separated rearward; and the seating parts may each include: a first connection part configured to be fixedly coupled to one side of the top of the support part; a second connection part configured to be fixedly coupled to the opposite side of the top of the support part; and first seating rods configured to be fixedly coupled at a plurality of locations spaced apart between the first and second connection parts and allow the rear wheels of the vehicle to be seated thereon.

The ladders may each include: rotation members configured to be provided on both sides of the ladder, respectively; connection rods configured to be fixedly coupled at a plurality of locations spaced apart between the rotation member and the rotation member adjacent to the former rotation member so that the rear wheel or front wheel of the vehicle can move thereon; second seating rods configured to be fixedly coupled at a plurality of locations between the rotation member and the rotation member adjacent to the former rotation member and be arranged in front of the connection rods so that the front wheel of the vehicle is seated thereon; first catch parts configured to be fixedly coupled to the lower rears of the rotation members so that they are caught on the first seating rods arranged at frontmost locations among the plurality of first seating rods when the ladders are hung on the upper fronts of the tire frames; second catch parts configured to be fixedly coupled to the bottoms of the rotation members and be provided in front of the first catch parts and spaced apart from the first catch parts so that they are caught on the first seating rods arranged at the frontmost locations among the plurality of first seating rods when the ladders are rotated counterclockwise; and stop parts configured to be fixedly coupled to the bottoms of the first catch parts in an inclined form and prevent the ladders from being separated forward.

The first supporters may each include: a first vertical member configured to be rotatably coupled to the front of one side of the rotation member at the top thereof and support the front of the ladder when the ladder is rotated counterclockwise; a first plate configured to be fixedly coupled to the bottom of the first vertical member and come into surface contact with the ground; and a first reinforcing member configured to be screw-coupled between the first vertical member and the rotation member; the second supporters may each include: a second vertical member configured to be rotatably coupled to the center of one side of the rotation member at a top thereof and support the center of the ladder when the ladder is rotated counterclockwise; a second plate configured to be fixedly coupled to the bottom of the second vertical member and come into surface contact with the ground; and a second reinforcing member configured to be screw-coupled between the second vertical member and the rotation member; and the third supporters may each include: a third vertical member configured to be fixedly coupled to the rear of one side of the rotation member at the top thereof and support the rear of the ladder; and a third plate configured to be fixedly coupled to the bottom of the third vertical member and come into surface contact with the ground.

A first through hole may be formed through the upper portion of one side of the first vertical member, a first fastening hole corresponding to the first through hole may be formed through the front portion of one side of the rotation member, a second through hole may be formed through the upper portion of one side of the second vertical member, a second fastening hole corresponding to the second through hole may be formed through the center of one side of the rotation member, and a third through hole may be formed through the upper portion of one side of the third vertical member.

In the container car shoring frame according to one embodiment of the present invention, a vehicle is disposed in an inclined form in an up-forward direction and then another vehicle is loaded horizontally in the space between the existing vehicle and the floor of a container, thereby providing the advantage of being able to maximally utilize the space inside the container in order to load vehicles thereinto.

In the container car shoring frame according to one embodiment of the present invention, the rear wheels of a vehicle are seated on the tops of the tire frames through the lifting ladder in the state in which the lifting ladder is hung on the upper fronts of the tire frames of the base frame and then the lifting ladder on which the front wheels of the vehicle are seated is rotated counterclockwise around the tire frames, so that the vehicle can be disposed in an inclined form in an up-forward direction, thereby providing the advantage of being able to load as many vehicles as possible inside a container.

In the container car shoring frame according to one embodiment of the present invention, another vehicle may be additionally loaded between the lifting ladder disposed in an inclined form in an up-forward direction and the bottom of a container, thereby providing the advantage of being able to reduce the transportation cost per vehicle during the export of vehicles.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a perspective view of a container car shoring frame when a lifting ladder is mounted on the ground;

FIG. 2 is a perspective view of the container car shoring frame when the lifting ladder is rotated;

FIG. 3 is a perspective view of a base frame;

FIG. 4 is a perspective view of the lifting ladder;

FIG. 5 is a plan view of the container car shoring frame shown in FIG. 1;

FIG. 6 is a sectional view of the container car shoring frame, shown in FIG. 5, which is taken along line AA;

FIG. 7 is a plan view of the container car shoring frame shown in FIG. 2;

FIG. 8 is a sectional view of the container car shoring frame, shown in FIG. 7, which is taken along line BB;

FIG. 9 is a side view of the container car shoring frame shown in FIG. 2;

FIG. 10 is a side view of a process in which a vehicle is seated on tire frames through the lifting ladder;

FIG. 11 is a side view of a process in which the lifting ladder is rotated counterclockwise and thus the front wheels of a vehicle are lifted; and

FIG. 12 is a side view of a process in which another vehicle enters the space between the lifting ladder and the ground.

### DETAILED DESCRIPTION

Embodiments of the present invention will be described in detail below with reference to the accompanying drawings in order to describe the present invention in detail so that a person having ordinary skill in the art to which the present invention pertains can easily practice the technical spirit of the present invention.

However, the following embodiments are merely examples intended to help understand the present invention, and the scope of the present invention is not limited or reduced by them. Furthermore, the present invention may be implemented in various different forms, and is not limited to the embodiments described herein.

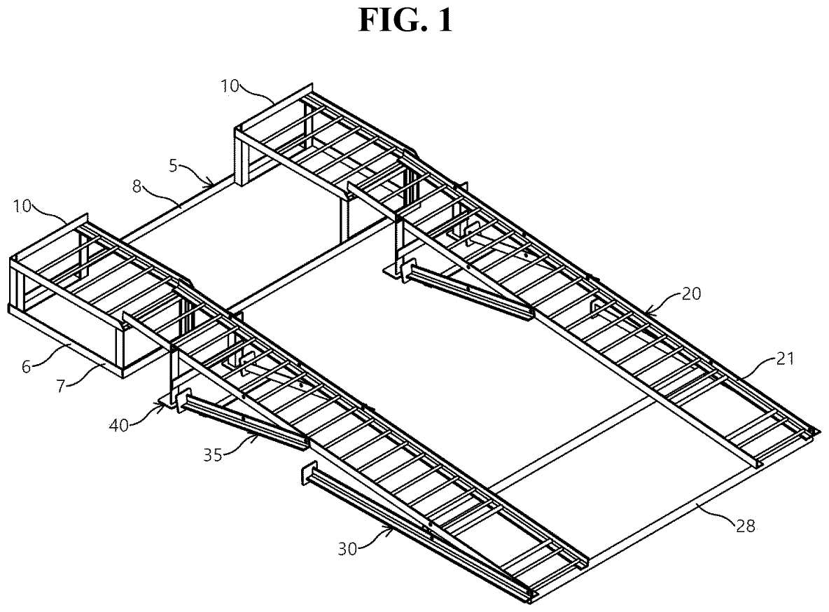

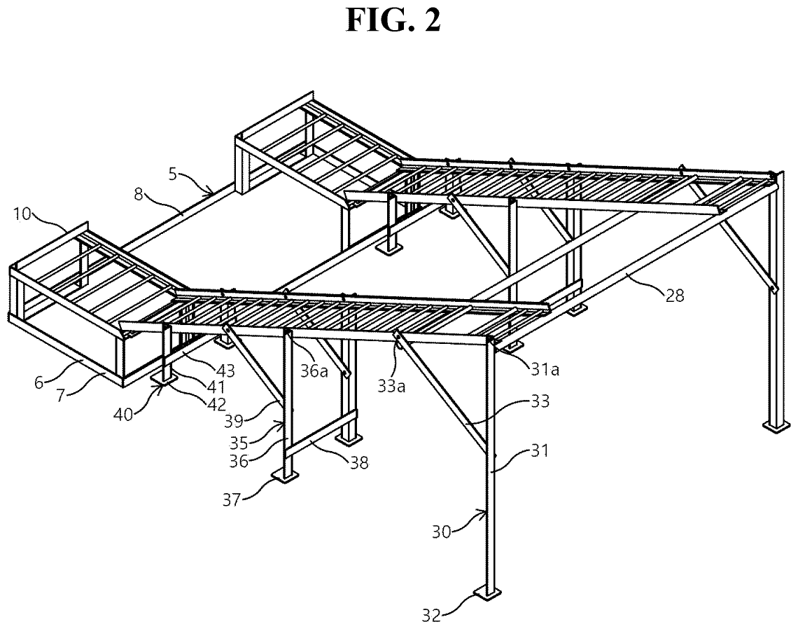

FIG. 1 is a perspective view of a container car shoring frame 1 when a lifting ladder 20 is mounted on the ground, and FIG. 2 is a perspective view of the container car shoring frame 1 when the lifting ladder 20 is rotated.

Referring to FIGS. 1 and 2, the container car shoring frame 1 according to one embodiment of the present invention includes a base frame 5, the lifting ladder 20, first supporters 30, second supporters 35, and third supporters 40.

First, the base frame 5 is mounted on the ground, and the rear wheels of a vehicle are seated on the top of the base frame 5.

Furthermore, the lifting ladder 20 is rotatably hung on the upper front of the base frame 5, and the front wheels of the vehicle are seated on the upper front of the lifting ladder 20.

Furthermore, the first supporters 30 are rotatably coupled to the front of the lifting ladder 20 at a plurality of locations, and support the front of the lifting ladder 20 when the lifting ladder 20 is rotated counterclockwise.

Furthermore, the second supporters 35 are rotatably coupled to the center of the lifting ladder 20 at a plurality of locations, and support the center of the lifting ladder 20 when the lifting ladder 20 is rotated counterclockwise.

Furthermore, the third supporters 40 are fixedly coupled to the rear of the lifting ladder 20 at a plurality of locations, and support the rear of the lifting ladder 20 when the lifting ladder 20 is hung on the upper front of the base frame 5.

Furthermore, the lifting ladder 20 is rotated counterclockwise to lift the front wheels of the vehicle.

Meanwhile, the base frame 5 includes a base part 6 and tire frames 10.

First, the base part 6 is mounted on the ground. Then, the tire frames 10 are fixedly coupled to both sides of the base part 6, respectively, and the rear wheels of the vehicle are seated on the tops of the tire frames 10.

Meanwhile, the lifting ladder 20 includes ladders 21 and horizontal members 28.

First, the rear ends of the ladders 21 are hung on the upper fronts of the tire frames 10 so that the rear wheels of the vehicle can be moved to the tire frames 10. In this case, the ladders 21 are provided on both sides of the lifting ladder 20, respectively.

Furthermore, the horizontal members 28 are fixedly coupled to the lower fronts of the ladders 21 at a plurality of locations. In this case, the horizontal members 28 each extend in the shape of a circular pipe in a left-right direction.

Referring to FIGS. 1 and 2, the base part 6 includes front-rear frames 7 and left-right frames 8.

First, the front-rear frames 7 are provided on both sides of the base frame 5, respectively. In this case, the front-rear frames 7 each extend in a front-rear direction.

Furthermore, the left-right frames 8 each connect the front-rear frame 7 and the front-rear frame 7 adjacent to the former front-rear frame 7. In this case, the left-right frames 8 each extend in a left-right direction.

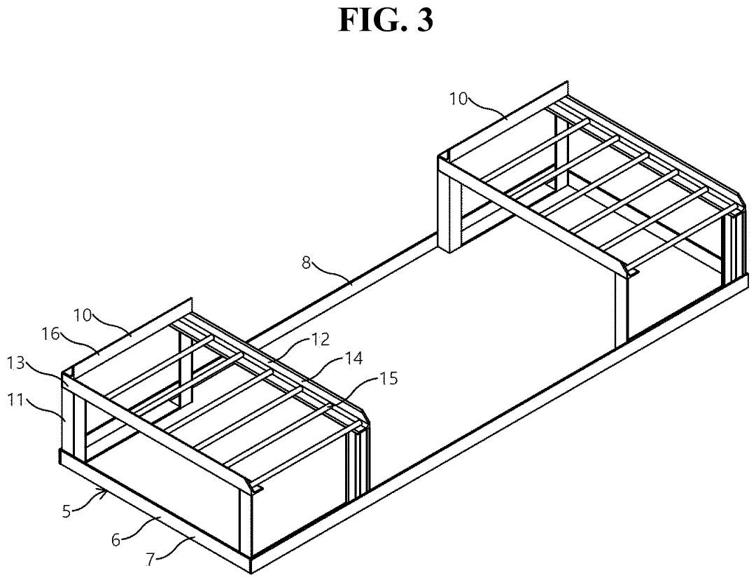

FIG. 3 is a perspective view of the base frame 5. Referring to FIG. 3, the tire frames 10 include support parts 11, seating parts 12, and stoppers 16.

First, the support parts 11 are fixedly coupled to both sides of the rear of the base part 6.

Furthermore, the seating parts 12 are fixedly coupled to the tops of the support parts 11, and the rear wheels of the vehicle are seated on the seating parts 12.

Furthermore, the stoppers 16 are fixedly coupled to the upper rears of the seating parts 12, and serve to prevent the rear wheels of the vehicle from being separated rearward.

Meanwhile, the seating parts 12 each include a first connection part 13, a second connection part 14, and first seating rods 15.

Furthermore, the first connection part 13 is fixedly coupled to one side of the top of the support part 11. In this case, the first connection part 13 extends in a front-rear direction.

Furthermore, the second connection part 14 is fixedly coupled to the opposite side of the top of the support part 11. In this case, the second connection part 14 is formed in a shape that is vertically symmetrical to that of the first connection part 13.

Furthermore, the first seating rods 15 are fixedly coupled at a plurality of locations spaced apart between the first and second connection parts 13 and 14, and the rear wheels of the vehicle are seated on the first seating rods 15. In this case, the first seating rods 15 each extend in the shape of a rod in a left-right direction.

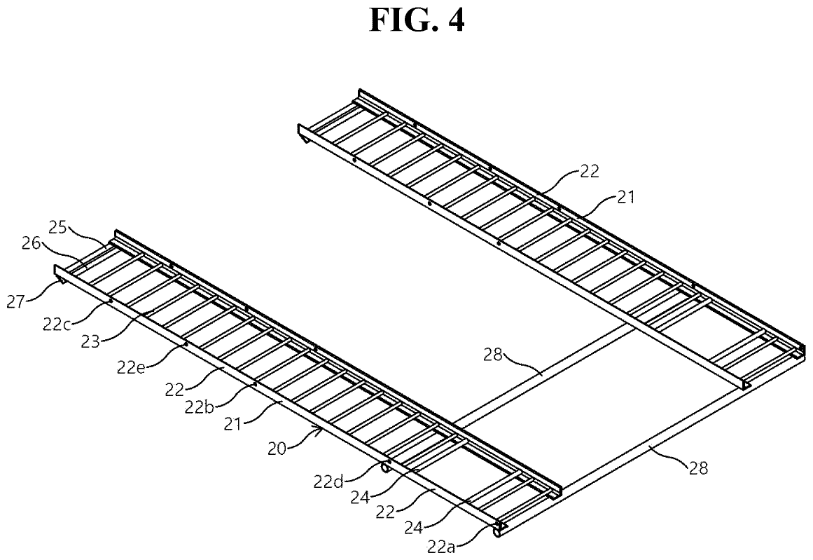

FIG. 4 is a perspective view of the lifting ladder 20. Referring to FIG. 4, the ladder 21 includes rotation members 22, connection rods 23, second seating rods 24, catch parts, and stop parts 27.

First, the rotation members 22 are provided on both sides of the ladder 21, respectively.

Furthermore, the connection rods 23 are fixedly coupled at a plurality of locations spaced apart between the rotation member 22 and the rotation member 22 adjacent to the former rotation member 22 so that the rear wheel or front wheel of the vehicle can move thereon. In this case, the connection rods 23 each extend in a shape of a rod in a left-right direction.

Furthermore, the second seating rods 24 are fixedly coupled at a plurality of locations between the rotation member 22 and the rotation member 22 adjacent to the former rotation member 22, and are arranged in front of the connection rods 23. Furthermore, the front wheel of the vehicle is seated on the second seating rods 24.

In this case, the second seating rods 24 each extend in the shape of a rod in a left-right direction, and the diameter of the second seating rods 24 is formed to be longer than that of the connection rods 23 so that the front wheel of the vehicle can be more easily seated thereon.

Furthermore, the interval between the second seating rods 24 is formed to be longer than that between the connection rods 23 so that the front wheel of the vehicle can be more easily seated thereon.

In this case, the interval between the second seating rods 24 refers to the interval between the second seating rod 24 and the second seating rod 24 adjacent to the former second seating rod 24. Furthermore, the interval between the connection rods 23 refers to the interval between the connection rod 23 and the connection rod 23 adjacent to the former connection rod 23.

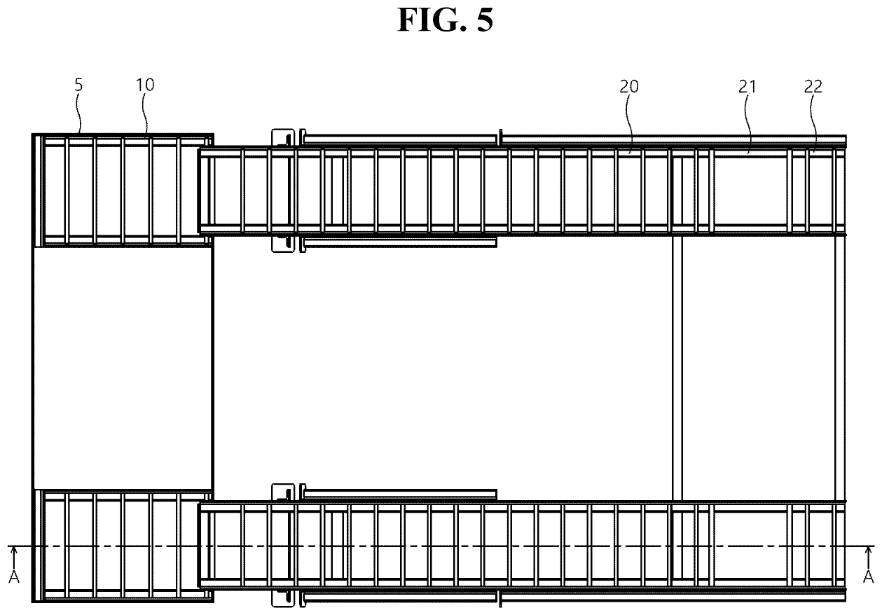

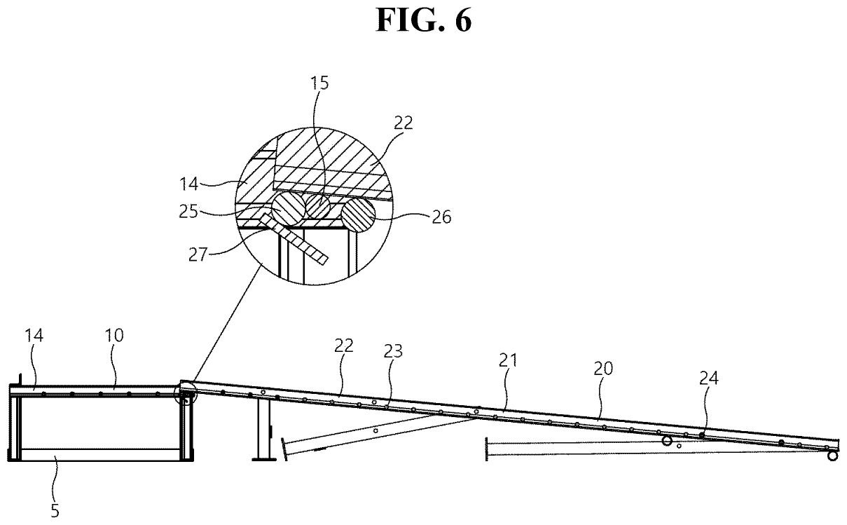

FIG. 5 is a plan view of the container car shoring frame 1 shown in FIG. 1, and FIG. 6 is a sectional view of the container car shoring frame 1, shown in FIG. 5, which is taken along line AA.

Referring to FIGS. 5 and 6, first catch parts 25 are fixedly coupled to the lower rears of the rotation members 22, so that they are caught on the first seating rods 15 arranged at the frontmost locations among the plurality of first seating rods 15 when the ladders 21 are hung on the upper fronts of the tire frames 10.

More specifically, when the ladders 21 are hung on the upper fronts of the tire frames 10, the ladders 21 are moved in a down-forward direction by their own weight, and thus, the first catch parts 25 are caught on the first seating rods 15 arranged at the frontmost locations of the tire frames 10.

In this case, the first catch parts 25 each extend in the shape of a rod in a left-right direction, and the diameter of the first catch parts 25 is formed to be longer than that of the first seating rods 15 so that the first catch parts 25 can be caught more easily on the first seating rods 15.

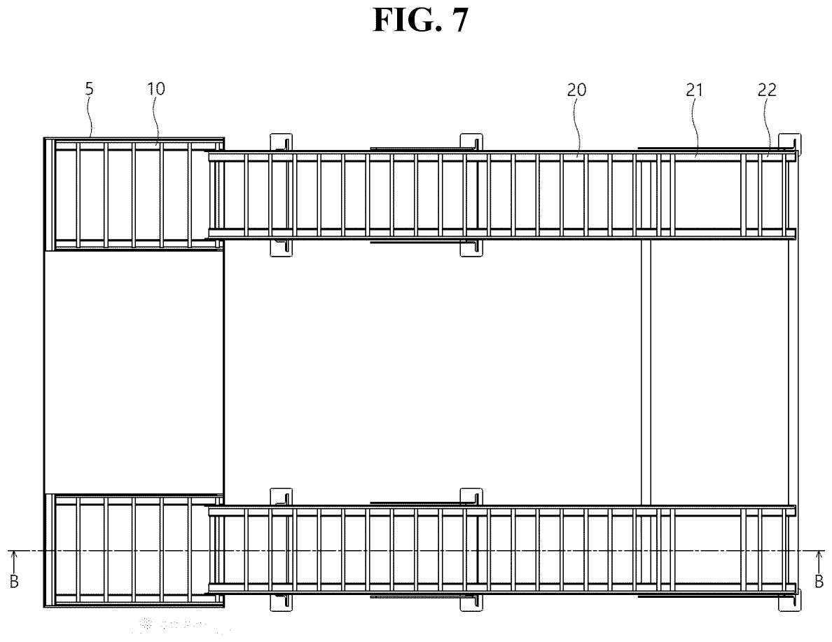

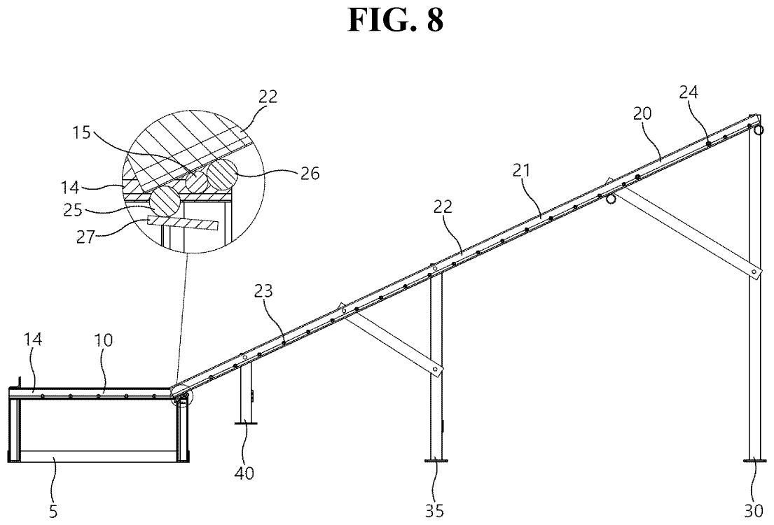

FIG. 7 is a plan view of the container car shoring frame 1 shown in FIG. 2, and FIG. 8 is a sectional view of the container car shoring frame 1, shown in FIG. 7, which is taken along line BB.

Referring to FIGS. 7 and 8, second catch parts 26 are fixedly coupled to the bottoms of the rotation members 22, and are provided in front of the first catch parts 25 and spaced apart from the first catch parts 25, so that they are caught on the first seating rods 15 arranged at the frontmost locations among the plurality of first seating rods 15 when the ladders 21 are rotated counterclockwise.

More specifically, when the ladders 21 are rotated counterclockwise, they are moved in a down-rearward direction due to their own weight, and thus, the second catch parts 26 are caught on the first seating rods 15 arranged at the frontmost locations of the tire frames 10. In this case, the second catch parts 26 are formed to have the same diameter and size as the first catch parts 25.

Furthermore, the stop parts 27 are fixedly coupled to the bottoms of the first catch parts 25 in an inclined form, and serve to prevent the ladders 21 from being separated forward. In this case, the stop parts 27 each extend in the shape of a plate having a predetermined thickness in a left-right direction.

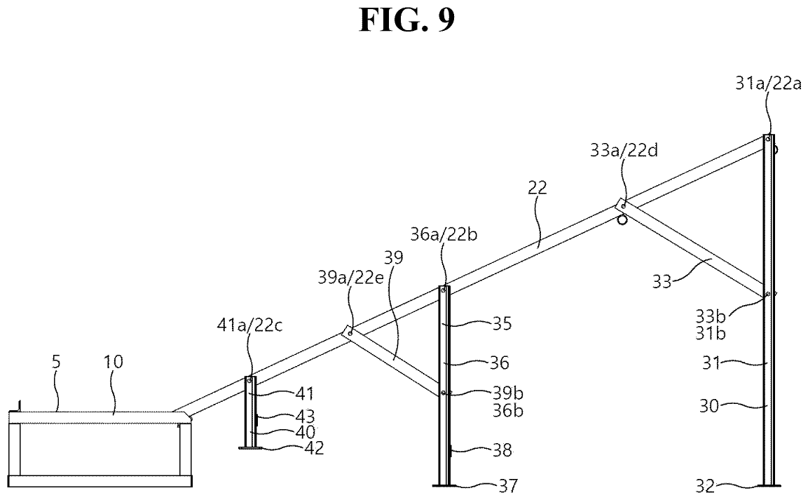

FIG. 9 is a side view of the container car shoring frame 1 shown in FIG. 2. Referring to FIGS. 2 and 9, the first supporters 30 each include a first vertical member 31, a first plate 32, and a first reinforcing member 33.

First, the first vertical member 31 is rotatably coupled to the front of one side of the rotation member 22 at the top thereof, and supports the front of the ladder 21 when the ladder 21 is rotated counterclockwise. In this case, the first vertical member 31 extends in a vertical direction.

Furthermore, the first plate 32 is fixedly coupled to the bottom of the first vertical member 31, and comes into surface contact with the ground. In this case, the first plate 32 is formed in the shape of a plate having a predetermined thickness.

Furthermore, the first reinforcing member 33 is screw-coupled between the first vertical member 31 and the rotation member 22. In this case, the first reinforcing member 33 is formed in the shape of a plate having a predetermined thickness.

Meanwhile, the second supporters 35 each include a second vertical member 36, a second plate 37, a first connection member 38, and a second reinforcing member 39.

First, the second vertical member 36 is rotatably coupled to the center of one side of the rotation member 22 at the top thereof, and supports the center of the ladder 21 when the ladder 21 is rotated counterclockwise. In this case, the second vertical member 36 extends in a vertical direction, and the height of the second vertical member 36 is formed to be lower than that of the first vertical member 31.

Furthermore, the second plate 37 is fixedly coupled to the bottom of the second vertical member 36, and comes into surface contact with the ground. In this case, the second plate 37 is formed to have the same shape and size as the first plate 32.

Furthermore, the first connection member 38 connects the second vertical member 36 and the second vertical member 36 adjacent to the former second vertical member 36.

Furthermore, the second reinforcing member 39 is screw-coupled between the second vertical member 36 and the rotation member 22. In this case, the second reinforcing member 39 is formed in the shape of a plate having a predetermined thickness.

Meanwhile, the third supporters 40 each include a third vertical member 41, a third plate 42, and a second connection member 43.

First, the third vertical member 41 is fixedly coupled to the rear of one side of the rotation member 22 at the top thereof, and supports the rear of the ladder 21. In this case, the third vertical member 41 extends in a vertical direction, and the height of the third vertical member 41 is formed to be lower than that of the second vertical member 36.

Furthermore, the third plate 42 is fixedly coupled to the bottom of the third vertical member 41, and comes into surface contact with the ground. In this case, the third plate 42 is formed to have the same shape and size as the first plate 32.

Furthermore, the second connection member 43 connects the third vertical member 41 and the third vertical member 41 adjacent to the former third vertical member 41.

Referring to FIGS. 2, 4, and 9, a first through hole 31a is formed through the upper portion of one side of the first vertical member 31. Furthermore, a first fastening hole 22a corresponding to the first through hole 31a is formed through the front portion of one side of the rotation member 22.

Furthermore, a second through hole 36a is formed through the upper portion of one side of the second vertical member 36. Furthermore, a second fastening hole 22b corresponding to the second through hole 36a is formed through the center of one side of the rotation member 22.

Furthermore, a third through hole 41a is formed through the upper portion of one side of the third vertical member 41. Furthermore, a third fastening hole 22c corresponding to the third through hole 41a is formed through the lower portion of one side of the rotation member 22.

Furthermore, a first fixing hole 33a is formed through the upper portion of one side of the first reinforcing member 33. Furthermore, a second fixing hole 33b is formed through the lower portion of one side of the first reinforcing member 33.

Furthermore, a first fastening hole 22d corresponding to the first fixing hole 33a is formed through the upper portion of one side of the first reinforcing member 22. Furthermore, a first coupling hole 31b corresponding to the second fixing hole 33b is formed through the center of one side of the first vertical member 31.

Furthermore, a third fixing hole 39a is formed through the upper portion of one side of the second reinforcing member 39. Furthermore, a fourth fixing hole 39b is formed through the lower portion of one side of the second reinforcing member 39.

Furthermore, a second fastening hole 22e corresponding to the third fixing hole 39a is formed through the one side of the rotating member 22. Furthermore, a second coupling hole 36b corresponding to the fourth fixing hole 39b is formed through the center of one side of the second vertical member 36.

Meanwhile, the operating principle of the container car shoring frame 1 according to one embodiment of the present invention is as follows:

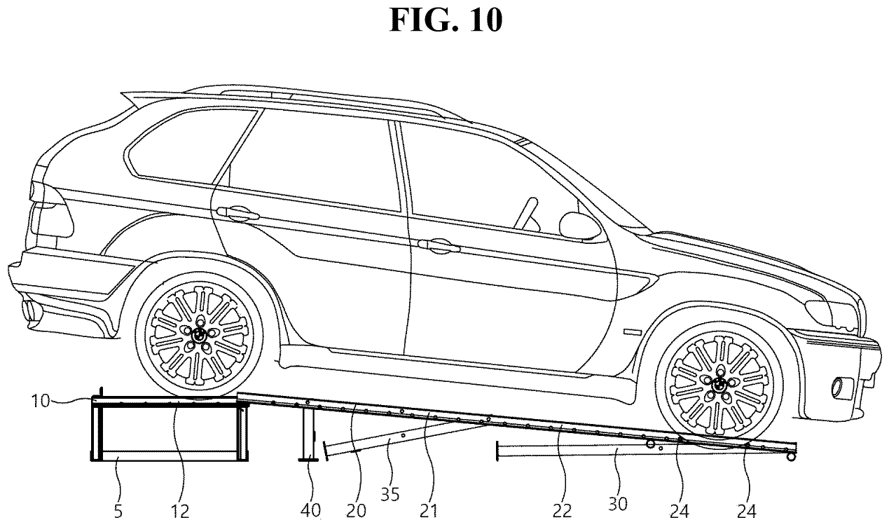

FIG. 10 is a side view of a process in which a vehicle is seated on the tire frames 10 through the lifting ladder 20.

Referring to FIG. 10, the ladder 21 is hung on the top of the tire frame 10. In this case, the third supporter 40 comes into surface contact with the ground. Furthermore, the first supporter 30 and the second supporter are each disposed in a rearward and lower direction.

Thereafter, a vehicle moves rearward and upward along the ladder 21 of the lifting ladder 20, so that the rear wheel of the vehicle is seated on the seating part 12 of the tire frame 10.

Thereafter, the front wheel of the vehicle is seated on the second seating rods 24 of the ladder 21.

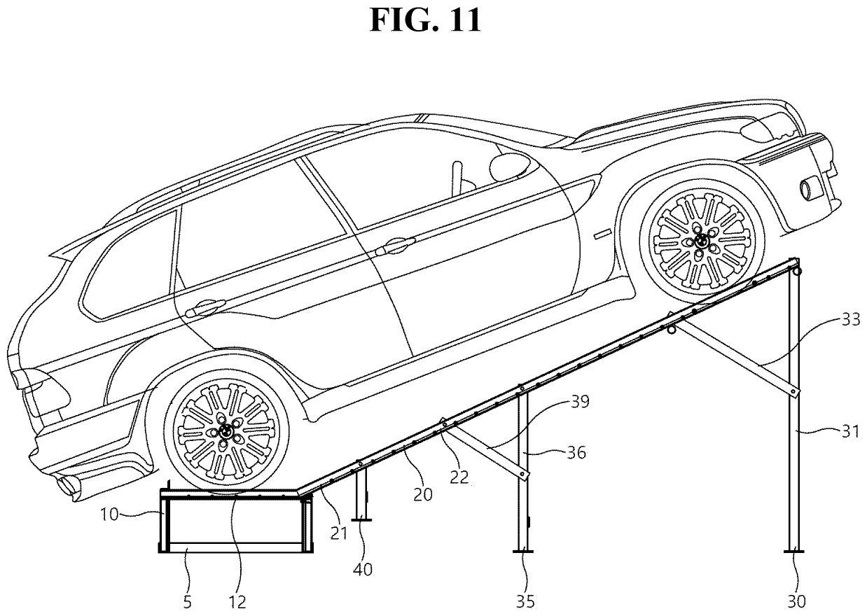

FIG. 11 is a side view of a process in which the lifting ladder 20 is rotated counterclockwise and thus the front wheels of a vehicle are lifted.

Referring to FIG. 11, the ladders 21 are rotated counterclockwise such that the lifting ladder 20 can lift the front wheels of the vehicle.

Thereafter, the first supporters 30 and the second supporters 35 are each rotated counterclockwise, erected upward, and come into contact with the ground.

Thereafter, the first reinforcing members 33 are screw-coupled between the first vertical members 31 and the rotation members 22 in order to support the fronts of the ladders 21.

In the same manner, the second reinforcing members 39 are screw-coupled between the second vertical members 36 and the rotation members 22 in order to support the centers of the ladders 21.

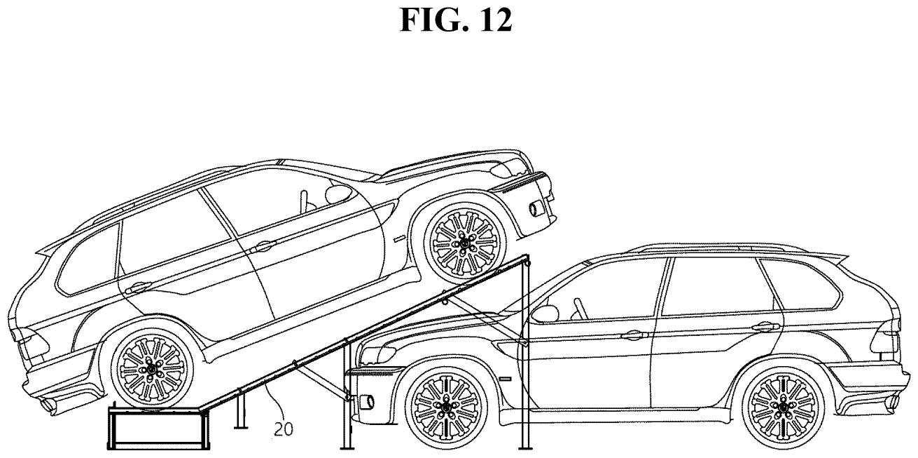

FIG. 12 is a side view of a process in which another vehicle enters the space between the lifting ladder 20 and the ground.

Referring to FIG. 12, the other vehicle moves rearward, so that the front of the other vehicle is accommodated in the space between the lifting ladder 20 and the ground.

In the container car shoring frame 1 according to one embodiment of the present invention, a vehicle is disposed in an inclined form in an up-forward direction and then another vehicle is loaded horizontally in the space between the existing vehicle and the floor of a container, thereby providing the advantage of being able to load vehicles while maximally utilizing the space inside the container.

In the container car shoring frame 1 according to one embodiment of the present invention, the rear wheels of a vehicle are seated on the tops of the tire frames 10 through the lifting ladder 20 in the state in which the lifting ladder 20 is hung on the upper fronts of the tire frames 10 of the base frame 5 and then the lifting ladder 20 on which the front wheels of the vehicle are seated is rotated counterclockwise around the tire frames 10, so that the vehicle can be disposed in an inclined form in an up-forward direction, thereby providing the advantage of being able to load as many vehicles as possible inside a container.

In the container car shoring frame 1 according to one embodiment of the present invention, another vehicle may be additionally loaded between the lifting ladder 20 disposed in an inclined form in an up-forward direction and the bottom of a container, thereby providing the advantage of being able to reduce the transportation cost per vehicle during the export of vehicles.

As described above, the present invention proposes the provision of the container car shoring frame 1 as its main technical spirit. The embodiments described above with reference to the drawings are only some examples. The true scope of the rights of the present invention is based on the scope of the attached claims, and also encompasses equivalent embodiments that may be present in various forms.

What is claimed is:

1. A container car shoring frame, comprising:
a base frame configured to be mounted on a ground and allow rear wheels of a vehicle to be seated on a top thereof;
a lifting ladder configured to be rotatably hung on an upper front of the base frame and allow front wheels of the vehicle to be seated on an upper front thereof;
first supporters configured to be rotatably coupled to a front of the lifting ladder and support the front of the lifting ladder when the lifting ladder is rotated counterclockwise;
second supporters configured to be rotatably coupled to a center of the lifting ladder and support the center of the lifting ladder when the lifting ladder is rotated counterclockwise; and
third supporters configured to be fixedly connected to a rear of the lifting ladder and support the rear of the lifting ladder when the lifting ladder is hung on the upper front of the base frame,
wherein the lifting ladder is rotated counterclockwise in order to lift the front wheels of the vehicle,
wherein the base frame comprises:
a base part configured to be mounted on the ground; and
tire frames configured to be fixedly coupled to both sides of the base part, respectively, and allow the rear wheels of the vehicle to be seated thereon,
wherein the lifting ladder comprises:
ladders configured such that rear ends thereof are hung on upper fronts of the tire frames in order to move the rear wheels of the vehicle to the tire frames; and
horizontal members configured to be fixedly coupled to lower fronts of the ladders at a plurality of locations spaced apart from each other,
wherein the tire frames comprise:
support parts configured to be fixedly coupled to both sides of a rear of the base part, respectively;
seating parts configured to be fixedly coupled to tops of the support parts and allow the rear wheels of the vehicle to be seated thereon; and
stoppers configured to be fixedly coupled to upper rears of the seating parts and prevent the rear wheels of the vehicle from being separated rearward,
wherein the seating parts each comprise:
a first connection part configured to be fixedly coupled to one side of a top of the support part;
a second connection part configured to be fixedly coupled to an opposite side of the top of the support part; and
first seating rods configured to be fixedly coupled at a plurality of locations spaced apart between the first and second connection parts and allow the rear wheels of the vehicle to be seated thereon, and
wherein the ladders each comprise:
rotation members configured to be provided on both sides of the ladder, respectively;
connection rods configured to be fixedly coupled at a plurality of locations spaced apart between the rotation member and the rotation member adjacent to the former rotation member so that the rear wheel or front wheel of the vehicle can move thereon;
second seating rods configured to be fixedly coupled at a plurality of locations between the rotation member and the rotation member adjacent to the former rotation member and be arranged in front of the connection rods so that the front wheel of the vehicle is seated thereon;
first catch parts configured to be fixedly coupled to lower rears of the rotation members so that they are caught on the first seating rods arranged at frontmost locations among the plurality of first seating rods when the ladders are hung on the upper fronts of the tire frames;
second catch parts configured to be fixedly coupled to bottoms of the rotation members and be provided in front of the first catch parts and spaced apart from the first catch parts so that they are caught on the first seating rods arranged at the frontmost locations among the plurality of first seating rods when the ladders are rotated counterclockwise; and
stop parts configured to be fixedly coupled to bottoms of the first catch parts in an inclined form and prevent the ladders from being separated forward.

2. The container car shoring frame of claim 1, wherein the first supporters each comprise:
a first vertical member configured to be rotatably coupled to a front of one side of the rotation member at a top thereof and support the front of the ladder when the ladder is rotated counterclockwise;
a first plate configured to be fixedly coupled to a bottom of the first vertical member and come into surface contact with the ground; and
a first reinforcing member configured to be screw-coupled between the first vertical member and the rotation member,
wherein the second supporters each comprises:
a second vertical member configured to be rotatably coupled to a center of one side of the rotation member at a top thereof and support a center of the ladder when the ladder is rotated counterclockwise;
a second plate configured to be fixedly coupled to a bottom of the second vertical member and come into surface contact with the ground; and
a second reinforcing member configured to be screw-coupled between the second vertical member and the rotation member, and
wherein the third supporters each comprise:
a third vertical member configured to be fixedly coupled to a rear of one side of the rotation member at a top thereof and support a rear of the ladder; and
a third plate configured to be fixedly coupled to a bottom of the third vertical member and come into surface contact with the ground.

3. The container car shoring frame of claim 2, wherein a first through hole is formed through an upper portion of one side of the first vertical member,
wherein a first fastening hole corresponding to the first through hole is formed through a front portion of one side of the rotation member,
wherein a second through hole is formed through an upper portion of one side of the second vertical member,
wherein a second fastening hole corresponding to the second through hole is formed through a center of one side of the rotation member, and
wherein a third through hole is formed through an upper portion of one side of the third vertical member.
